(19) United States
(12) Patent Application Publication
(10) Pub. No.: US 2021/0240179 A1
(43) Pub. Date: Aug. 5, 2021

(54) AUTOMATED MAINTENANCE METHOD AND SYSTEM FOR PLANT ASSETS

(71) Applicant: SAUDI ARABIAN OIL COMPANY, Dhahran (SA)

(72) Inventors: Nabeel Akhtar Mallick, Udhailiyah (SA); Adel O BenDuheash, Udhailiyah (SA); Mishaal Alhetairshi, Udhailiyah (SA)

(73) Assignee: SAUDI ARABIAN OIL COMPANY, Dhahran (SA)

(21) Appl. No.: 16/778,856

(22) Filed: Jan. 31, 2020

(51) Int. Cl. G05B 23/02; H04L 29/06; G06Q 10/00; G06Q 50/04; G06Q 10/10; G06F 16/23; B23Q 17/00

(52) U.S. Cl. CPC G05B 23/0283; H04L 67/42; G06Q 10/20; B23Q 17/00; G06Q 10/10; G06F 16/2379; G06Q 50/04

(57) ABSTRACT

A server is configured as a translator between a data source and a client. The data source detects at least one diagnostic parameter from a field device. The server outputs a value of the at least one diagnostic parameter to the client in real time. The client identifies one or more active error messages from the value of the at least one diagnostic parameter. A maintenance trouble ticket is automatically generated based on the one or more active error messages.

### FIELD

The disclosure relates generally to industrial automation and automated maintenance systems for plant assets.

### BACKGROUND

Smart field devices that communicate via Highway Addressable Remote Transducer (“HART”) communication protocol are widely used in the hydrocarbon industry. HART is a hybrid analog and digital protocol that provides data access between smart field devices and host systems. HART analog signal includes HART diagnostic status carrying field device malfunction, primary variable out of limit, loss of communication values, and so on. HART digital signal from smart field devices includes instrument status, process values, diagnostic data, alarms and alert messages, and so on. Each HART smart field device carries different diagnostic information, and this information varies with the manufacturer and model of the instruments.

In the current industry practice, the HART diagnostic information and alert messages contained in HART digital signal are going undetected if the status of the primary variable stays “GOOD” and if the HART data is not manually monitored or accessed using tools (e.g., Handheld HART communicator and computers with HART modem) or third party applications (e.g., instrument asset management system).

In the industry, maintenance of field devices has been traditionally achieved through time-based tasks, where the maintenance work performed on the field devices is based on predetermined schedules, irrespective of the condition of the field devices. In the traditional approach to maintenance, a field device may suffer a breakdown before the next scheduled maintenance. If the breakdown occurs before the next scheduled maintenance, the personnel and parts to make the repair or replacement may not be readily available, which may lead to significant unplanned downtime in the plant.

Predictive or condition-based maintenance systems have been proposed where maintenance is triggered when certain conditions are met. However, predictive maintenance systems tend to be complicated and rely primarily on historical maintenance data.

### SUMMARY

In one aspect, a method for automated maintenance of plant assets may be summarized as including configuring a server as a translator between a data source and a client; detecting, by the data source, at least one diagnostic parameter from a field device; outputting, by the server, a parameter value of the at least one diagnostic parameter to the client in real time; identifying, by the client, one or more active error messages from the parameter value of the at least one diagnostic parameter; and automatically generating a maintenance trouble ticket based on the one or more active error messages.

The server may be configured as an Open Platform Communications (OPC) server.

An asset management system may be provided as the data source.

A distributed control system may be provided as the client.

Data may be transmitted from the field device by HART protocol.

Configuration of the server may include retrieving a list of error messages associated with the at least one diagnostic parameter from the data source and assigning an error value to each of the error messages in the list of error messages.

Identification of one or more active error messages from the parameter value of the at least one diagnostic parameter may include decoding, by the client, the parameter value of the at least one diagnostic parameter.

The method may include generating, by the client, a plurality of maintenance trouble ticket parameters based on the one or more active error messages and instrument data transmitted by the field device.

The method may include receiving, by the client, the instrument data transmitted by the field device.

Automatic generation of the maintenance trouble ticket based on the active error message(s) may include populating the maintenance trouble ticket with a content of the plurality of maintenance trouble ticket parameters.

Automatic generation of the maintenance trouble ticket based on the active error message(s) may include generating the maintenance trouble ticket in an enterprise resource planning (ERP) system.

Automatic generation of the maintenance trouble ticket based on the active error message(s) may include logging the maintenance trouble ticket parameters in a data historian. The data historian may populate the maintenance trouble ticket with the content of the plurality of maintenance trouble ticket parameters.

The data historian may generate the maintenance trouble ticket in the ERP system.

Generation of the maintenance trouble ticket in the ERP system by the data historian may include establishing a secured communication between a first network communicatively coupled to the data historian and a second network communicatively coupled to the ERP system.

Automatic generation of the maintenance trouble ticket based on the active error message(s) may be triggered by the client.

The method may include generating a health status report based on the active error message(s) and at least one of displaying and printing the health status report.

In another aspect, a system for monitoring maintenance of plant assets may be summarized as including a computerized control system for a plant; a computerized database system to receive at least one diagnostic parameter from at least one field device; and a server configured as a translator between the computerized database system and the computerized control system, the server to output a parameter value of the at least one diagnostic parameter to the computerized control system in real time; wherein the computerized control system includes instructions that when executed by a processor cause the computerized control system to identify one or more active error messages from the parameter value of the at least one diagnostic parameter and generate a plurality of maintenance trouble ticket parameters based on the one or more active error messages.

The computerized database system may be an asset management system.

The computerized control system may be a distributed control system.

The at least one field device may be a field device that communicates with HART protocol.

In yet another aspect, a non-transitory computer readable medium may have recorded thereon instructions that when executed by a processor associated with a client causes the client to: communicate with a server that is configured as a translator between the client and a data source; receive in real time a parameter value of at least one diagnostic parameter associated with a field device from the data source via the server; identify one or more active error messages from the parameter value of the at least one diagnostic parameter; and trigger automatic generation of a maintenance trouble ticket based on the one or more active error messages.

The foregoing general description and the following detailed description are exemplary of the invention and are intended to provide an overview or framework for understanding the nature of the invention as it is claimed. The accompanying drawings are included to provide further understanding of the invention and are incorporated in and constitute a part of the specification. The drawings illustrate various embodiments of the invention and together with the description serve to explain the principles and operation of the invention.

### BRIEF DESCRIPTION OF DRAWINGS

The following is a description of the figures in the accompanying drawings. In the drawings, identical reference numbers identify similar elements or acts. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIG. 1 is a schematic diagram of a system for monitoring maintenance of assets in a plant.

FIG. 2 is a flow diagram illustrating a method of monitoring maintenance of assets in a plant.

### DETAILED DESCRIPTION

In the following detailed description, certain specific details are set forth in order to provide a thorough understanding of various disclosed implementations and embodiments. However, one skilled in the relevant art will recognize that implementations and embodiments may be practiced without one or more of these specific details, or with other methods, components, materials, and so forth. In other instances, well known features or processes associated with the hydrocarbon production systems have not been shown or described in detail to avoid unnecessarily obscuring descriptions of the implementations and embodiments. For the sake of continuity, and in the interest of conciseness, same or similar reference characters may be used for same or similar objects in multiple figures. For the sake of brevity, the term “corresponding to” may be used to describe correspondence between features of different figures. When a feature in a first figure is described as corresponding to a feature in a second figure, the feature in the first figure is deemed to have the characteristics of the feature in the second figure, and vice versa, unless stated otherwise.

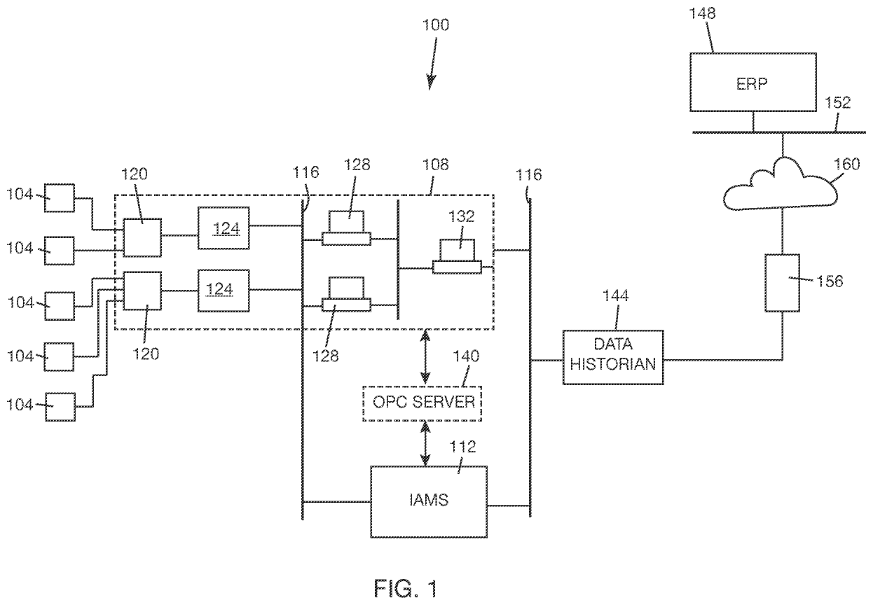

FIG. 1 is a diagram showing a system 100 for monitoring maintenance of assets in a plant according to one implementation. In one example, assets to be monitored are field devices with various functionalities. For illustrative purposes field devices 104 are shown. In general, a plant may have tens to hundreds of field devices interacting with various processes in the plant. A field device measures a physical parameter, e.g., pressure, temperature, flow, position, loop current, or the like, and generates an output signal that is proportional to the measured input. The field device is “smart” when it includes a microprocessor and memory to make calculations and a digital communication protocol that can be used to read values measured by the device and configure the device. In one example, field devices 104 are smart field devices that implement Highway Addressable Remote Transducer (“HART”) communication protocol. HART-based devices produce both analog and digital signals. The HART analog signal, also known as the primary variable, may include HART diagnostic status carrying field device malfunction, primary variable out of limit, loss of communication values, and other data. The HART digital signal may include instrument status, process values, diagnostic data, alarms and alert messages, and other information.

System 100 includes a distributed control system (DCS) 108 on a plant network 116. A DCS is a computerized control system for a process or plant. There are many ways in which a DCS could be configured, and the configuration of DCS 108 as illustrated in FIG. 1 is not intended to be limiting. For illustrative purposes, DCS 108 may include input/output (I/O) modules 120 and their associated distributed controllers 124, supervisory computers 128 (e.g., servers and engineering workstations), and coordinating computer(s) 132 (e.g., operator stations). I/O modules 120 are in communication with field devices 104. Supervisory computers 128 collect information from controllers 124 and provide the information to coordinating computers 132.

System 100 includes an instrument an asset management system (“IAMS”) 112 on plant network 116. IAMS 112 can be any computerized database system capable of tracking and monitoring assets. As an example, IAMS 112 may include one or more electronic databases containing description of assets (e.g., field devices 104), logic to update the database(s), logic to view the content of the database(s). IAMS 112 may further include logic to generate reports, alarms, and events based on the content of the database(s). IAMS 112 also includes processor(s) (not shown separately) to execute the logic and memory (not shown separately) to store the database(s) and IAMS logic.

In one example, I/O modules 120 receive HART signals from field devices 104 and transmit the HART signals to controllers 124. In one example, controller 124 extracts HART analog signal from an HART signal received from a corresponding I/O module 120 and provides the HART analog signal to supervisory computer(s) 128. The HART analog signal carries the primary variable and HART diagnostic status from field device 104. In one example, controller 124 extracts HART digital signal from an HART signal received from a corresponding I/O module 120 and provides the HART digital signal to IAMS 112. The HART digital signal carries HART diagnostic data, alarms, and alert messages. The HART digital signal may also carry other information, such as instrument status and process values. Controllers 124 may communicate with IAMS 112 via HART protocol or a serial protocol such as MODBUS protocol.

System 100 includes an Open Platform Communications or OLE for Process Control (“OPC”) server 140. OPC server 140 is a software application that complies with one or more OPC specifications. OPC 140 servers as a translator (or connector) between IAMS 112 (data source) and DCS 108 (OPC client). OPC 140 is configured to transfer diagnostic data in real time from IAMS 112 to DCS 108. Such configuration may be achieved by running an OPC server on a computer, e.g., a supervisory computer within DCS 108, and configuring connections between IAMS 112 and DCS 108 through the OPC sever console. DCS 108 includes logic, hereafter DCS health logic, that when executed by a processor extracts active error(s) for a field device from the diagnostic data received from IAMS 112. DCS health logic may generate maintenance trouble ticket parameters using the active errors and other identifying information from the field device. The maintenance trouble ticket parameters may be used to populate a maintenance trouble ticket. DCS health logic may generate a health status report of the field device, which may be sent to a printer or displayed on a workstation. DCS health logic may be stored on a non-transitory computer readable medium (e.g., random access memory, cache memory, hard disk, optical drive, flash memory, and the like) as instructions that are executable by a processor. The processor may be any suitable processor in DCS, e.g., a processor associated with any of controllers 124 and computers 128, 132. DCS health logic may be implemented as part of the control logic of DCS 108.

System 100 includes a data historian 144, which is a system that collects and logs production and process data in a time-series database. One commercial example of a data historian that may be used in a plant is PI System by OSIsoft. Data historian 144 may use a commercial data historian software with additional logic to enable automatic generation of maintenance trouble tickets. Data historian 140 is shown as being in communication with IAMS 112 and DCS 108. In general, as changes are made to the data contained in IAMS 112 and DCS 108, the changes are detected and logged by data historian 140, by time. The maintenance trouble ticket parameters generated by device health logic in DCS 108 are logged by data historian 144. In one implementation, data historian 144 includes logic that is executed when maintenance trouble ticket parameters are logged. The logic creates a maintenance trouble ticket and populates the maintenance trouble ticket with the maintenance trouble ticket parameters. As such, DCS health logic triggers automatic generation of maintenance trouble tickets.

System 100 includes an enterprise resource planning (“ERP”) system 148 on a second network, e.g., a corporate network 152. An ERP system 148 is used to manage core processes needed to run an enterprise, such as sales, finance, human resources, manufacturing, supply chain, and others. ERP software integrates the various core processes into one complete system so that data can be shared between the systems. At the core of the ERP system is a shared database. Examples of ERP systems are SAP® ERP, Netsuite ERP, and Sage ERP.

In one example, data historian 144 creates a maintenance trouble ticket in ERP system 148. That is, data historian 144 is integrated into ERP system 148 as a module. ERP system 148 may include an automated notification module that immediately notifies the maintenance personnel and other stakeholders of any maintenance trouble tickets created. In one implementation, for security reasons, plant network 116 is a protected network that is behind a firewall 156. As a module of ERP system 148, data historian system 144 has secured communication with ERP system 148 through firewall 156 and over a network 160. In this way, data historian 140 acts as a tunnel between plant network 116 and corporate network 152.

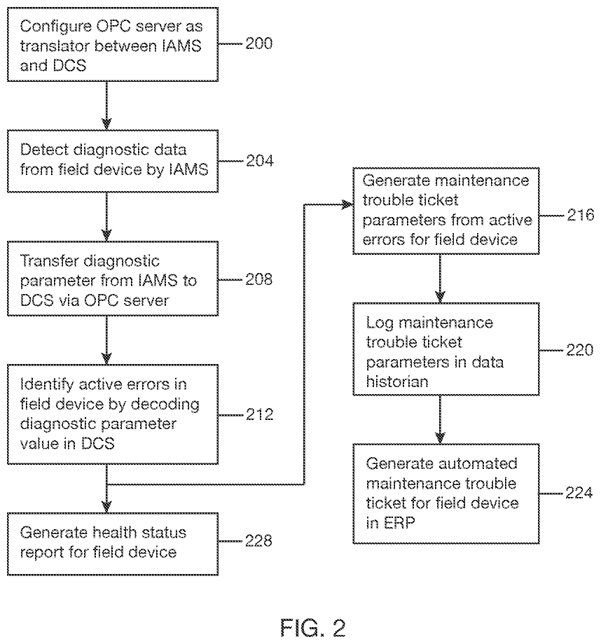

FIG. 2 is a flowchart illustrating a method of monitoring assets in a plant according to one implementation. The method is described in the context of monitoring one field device. However, the method could be extended to any number of field devices and assets. At 200, OPC server (140 in FIG. 1) is configured as a translator between IAMS 112 (data source) and DCS 108 (OPC client). OPC server is configured as a translator to enable transfer of diagnostic parameter(s) from IAMS (112 in FIG. 1) to DCS (108 in FIG. 1) for a specific field device. If there are multiple field devices, the OPC server will be configured separately for each field device.

HART diagnostic data outputted by a smart field device carries various information in the form of bits of data called parameters. The types of parameters, number of parameters, and parameter labels will generally vary based on manufacturer and model of smart field device. For illustrative purposes, consider a smart field device having diagnostic parameters with the following labels: xmtr_specific_status_0 and xmtr_specific_status_1. Table 1 shows examples of error messages that may be contained in these diagnostic parameters (the error messages are merely for illustrative purposes, and error messages will generally depend on the type of smart field device, manufacturer of the device, and model of the device). The value of diagnostic parameter xmtr_specific_status_0 depends on which of the error messages below xmtr_specific_status_0 is active, and the value of diagnostic parameter xmtr_specific_status_1 depends on which of the error messages listed below xmtr_specific_status_1 is active. The mark X next to an error message indicates that the error message is active.

TABLE 1

| | xmtr_specific_status_0 | | xmtr_specific_status_1 |
|---|---|---|---|
| | D/A not being updated | | Temperature coefficients |
| | | | checksum error |
| X | No pressure updates | | Software error #3 |
| | No temperature updates | | Software error #2 |
| | ROM checksum error | | Software error #1 |
| | Module EEPROM write failure | | Sensor board not initialized |
| | CPU EEPROM write failure | | CPU board not initialized |
| | Local buttons operator error | X | Incompatible CPU board & |
| | | | module |

To configure OPC server to enable transfer of diagnostic parameter(s) from IAMS to DCS for a specific smart field device, the diagnostic parameters for the smart field device recorded on IAMS are browsed from the OPC server. Table 2 shows an example of browsing diagnostic parameters on IAMS from an OPC server. The diagnostic parameters are presented in a directory structure. From this directory structure, it is possible to expand each diagnostic parameter to see the list of error messages associated with the diagnostic parameter and the order in which the error messages are listed.

TABLE 2

| | |
|---|---|
| v | xmtr_specific_status_0 |

| | |
|---|---|
| - | 0x01 D/A not being updated |
| - | 0x02 No pressure updates |
| - | 0x04 No temperature updates |
| - | 0x10 ROM checksum error |
| - | 0x20 Module EEPROM write failure |
| - | 0x40 CPU EEPROM write failure |
| - | 0x80 Local buttons operator error |

| | |
|---|---|
| > | xmtr_specific_status_1 |

The error messages are assigned values in powers of 2. For example, the value for the first error in a column of errors is 2⁰, the second error is 2¹, and so on. The diagnostic parameter value may be visualized as an 8-bit word. If only the first error in the diagnostic parameter is active, then the value of the diagnostic parameter would be 00000001=2⁰. If only the second error in the diagnostic parameter is active, then the value of the diagnostic parameter would be 00000010=2¹. If only the third error in the diagnostic parameter is active, then the value of the diagnostic parameter would be 00000100=2². If the first and third errors in the diagnostic parameter active, for example, then the value of the diagnostic parameter would be 00000101=2²+2⁰. If no error is active, the value of the diagnostic parameter would be 00000000=0. For the example shown in Table 1, xmtr_specific_status_0 would have a diagnostic parameter value of 00000010=2¹. For each diagnostic parameter selected during the configuration, as the diagnostic parameter changes on IAMS, OPC server will write the corresponding value of the diagnostic parameter to DCS as a variable. Writing the value as a variable means that some memory address is allocated in DCS to contain the diagnostic parameter value.

At 204, IAMS detects HART diagnostic data transmitted by a smart field device in real time. At 208, OPC server transfers each diagnostic parameter of the smart field device from IAMS to DCS by writing the value of the diagnostic parameter to DCS as a variable. Via the OPC server, there is link between a memory address in IAMS containing the diagnostic parameter and a memory address in DCS containing the value of the diagnostic parameter that is written by OPC server. As the data in the memory address in IAMS is updated, the data in the corresponding memory address in DCS will be updated in real time. At 212, logic in DCS monitors the memory address (variable) assigned to a diagnostic parameter and reads the data, which is the diagnostic parameter value, in the memory address. DCS health logic has the information needed to map the diagnostic parameter value to active errors in the diagnostic parameter. This information can be determined during browsing of IAMS and configuration of OPC server to transfer the diagnostic parameter from IAMS to DCS, as previously illustrated. For example, if a variable representing xmtr_specific_status_0 is written in DCS, and the value of xmtr_specific_status_0 is 5 (2²+2⁰), DCS health logic will be able to determine that the first and third errors in xmtr_specific_status_0 are active.

At 216, if there are active error(s) in the diagnostic parameter(s) of the smart field device, DCS health logic generates maintenance parameters for the smart field device. These maintenance parameters may include, for example, tag name of the smart field device, ERP name of the smart field device, the error messages in the smart field device, the status of the smart field device, the data and time of failure of the smart field device. DCS uses a combination of instrument data, e.g., information available from the HART analog signal or other portion of the HART signal received at DCS and other instrument data stored in DCS, and diagnostic information transferred from IAMS to generate the maintenance parameters. At 220, the maintenance parameters are logged in the data historian (144 in FIG. 1). At 224, data historian software creates an automated maintenance ticket in the ERP system (148 in FIG. 1). This may include establishing a secure communication link between the data historian system and the ERP system and transmitting a message including the maintenance parameters to the system ERP with a request to create the maintenance trouble ticket (or transmitting a message including the maintenance trouble ticket to ERP). For illustrative purposes, Table 3 shows a portion of an example of a maintenance trouble ticket. The date, description, location, and MMT Contact ID are arbitrary and for illustration purposes only.

TABLE 3

| Date | 7/10/2019 10:54 AM | Minor Maintenance Ticket |
|---|---|---|
| | | (MMT)Work Order |
| Order Type | Minor Maintenance | |
| Priority | 3 | Normal |
| Description | U24-PT-1099 | Transmitter Internal Error |
| Equipment | | |
| Location | U24 | |
| MMT Contact ID | 12345 | |

In some cases, at 228, DCS health logic may generate a health status report. DCS health logic may send the health status report to printer(s) at the plant or display the health status report on a display screen, e.g., a display screen associated with a DCS workstation or a display screen associated with a handheld device or the like. Table 4 shows an example of a health status report generated for a collection of field devices. The tag names, date, and error message shown in Table 4 are arbitrary and for illustration purposes only. Health status reports may be generated for a collection of field devices for which OPC server has been configured to act as a translator between IAMS and DCS. In the STATUS field, instead of indicating “Bad” when the device has an error, the actual device error can be printed. The health status report may serve as an early warning notification to operation and maintenance when the condition of the instrument health is compromised.

TABLE 4

| TAG NAME | STATUS |
|---|---|
| Date | 10/29/2019 11:43 |
| U33-TI-715 | Good |
| U33-TI-716 | Good |
| U33-TI-702 | Good |
| U33-TI-717 | No Pressure Updates |
| U33-TI-711 | Good |
| U33-TI-721 | Good |
| U33-TI-722 | Good |
| U33-TI-704 | Good |
| U33-TI-720 | Good |
| U33-TI-712 | Good |
| U33-PI-1013 | Good |

While the invention has been described with respect to a limited number of embodiments, those skilled in the art, having the benefit of this disclosure, will appreciate that other embodiments can be devised that do not depart from the scope of the invention as described herein. Accordingly, the scope of the invention should be limited only by the accompanying claims.

What is claimed is:

1. A method for automated maintenance of plant assets, the method comprising:
configuring a server as a translator between a data source and a client;
detecting, by the data source, at least one diagnostic parameter from a field device;
outputting, by the server, a parameter value of the at least one diagnostic parameter to the client in real time;
identifying, by the client, one or more active error messages from the parameter value of the at least one diagnostic parameter; and
automatically generating a maintenance trouble ticket based on the one or more active error messages.

2. The method of claim 1, wherein configuring a server as a translator between a data source and a client comprises configuring the server as an Open Platform Communications (OPC) server.

3. The method of claim 2, wherein configuring a server as a translator between a data source and a client comprises providing an asset management system as the data source.

4. The method of claim 3, wherein configuring a server as a translator between a data source and a client comprises providing a distributed control system as the client.

5. The method of claim 4, wherein detecting, by the data source, at least one diagnostic parameter from a field device comprises detecting data transmitted from the field device by Highway Addressable Remote Transducer (HART) protocol.

6. The method of claim 5, wherein configuring a server as a translator between a data source and a client comprises retrieving a list of error messages associated with the least one diagnostic parameter from the data source and assigning an error value to each of the error messages in the list of error messages.

7. The method of claim 6, wherein identifying, by the client, one or more active error messages from the parameter value of the at least one diagnostic parameter comprises decoding the parameter value of the at least one diagnostic parameter.

8. The method of claim 7, further comprising generating, by the client, a plurality of maintenance trouble ticket parameters based on the one or more active error messages and instrument data transmitted by the field device.

9. The method of claim 8, further comprising receiving, by the client, the instrument data transmitted by the field device.

10. The method of claim 8, wherein automatically generating a maintenance trouble ticket based on the one or more active error messages comprises populating the maintenance trouble ticket with a content of the plurality of maintenance trouble ticket parameters.

11. The method of claim 10, wherein automatically generating a maintenance trouble ticket based on the one or more active error messages comprises generating the maintenance trouble ticket in an enterprise resource planning (ERP) system.

12. The method of claim 11, wherein automatically generating a maintenance trouble ticket based on the one or more active error messages comprises logging the maintenance trouble ticket parameters in a data historian, and wherein populating the maintenance trouble ticket with a content of the plurality of maintenance trouble ticket parameters is by the data historian.

13. The method of claim 12, wherein generating the maintenance trouble ticket in an ERP system comprises generating the maintenance trouble ticket in the ERP system by the data historian.

14. The method of claim 13, wherein generating the maintenance trouble ticket in the ERP system by the data historian comprises establishing a secured communication between a first network communicatively coupled to the data historian and a second network communicatively coupled to the ERP system.

15. The method of claim 1, wherein automatically generating a maintenance trouble ticket based on the one or more active error messages is triggered by the client.

16. The method of claim 1, further comprising generating a health status report based on the one or more active error messages and at least one of displaying and printing the health status report.

17. A system for monitoring maintenance of plant assets, the system comprising:
a computerized control system for a plant;
a computerized database system to receive at least one diagnostic parameter from at least one field device; and
a server configured as a translator between the computerized database system and the computerized control system, the server to output a parameter value of the at least one diagnostic parameter to the computerized control system in real time;
wherein the computerized control system comprises instructions that when executed by a processor causes the computerized control system to:
identify one or more active error messages from the parameter value of the at least one diagnostic parameter; and
generate a plurality of maintenance trouble ticket parameters based on the one or more active error messages.

18. The system of claim 17, wherein the computerized database system is an asset management system, and wherein the computerized control system is a distributed control system.

19. The system of claim 17, wherein the at least one field device is a field device communicating with Highway Addressable Remote Transducer (HART) protocol.

20. A non-transitory computer readable medium having recorded thereon instructions that when executed by a processor associated with a client causes the client to:
communicate with a server that is configured as a translator between the client and a data source;
receive in real time a parameter value of at least one diagnostic parameter associated with a field device from the data source via the server;
identify one or more active error messages from the parameter value of the at least one diagnostic parameter; and
trigger automatic generation of a maintenance trouble ticket based on the one or more active error messages.
